(19) United States
(12) Patent Application Publication
(10) Pub. No.: US 2023/0012363 A1
(43) Pub. Date: Jan. 12, 2023

(54) BATTERY DEVICE AND USE THEREOF IN A MOTOR VEHICLE

(71) Applicant: Mahle International GmbH, Stuttgart (DE)

(72) Inventors: Michael Moser, Ellwangen (DE); Georg Votteler, Backnang (DE); Johannes Weinmann, Stuttgart (DE)

(21) Appl. No.: 17/860,101

(22) Filed: Jul. 8, 2022

(30) Foreign Application Priority Data
Jul. 8, 2021 (DE) 10 2021 207 252.6

(51) Int. Cl. H01M 10/6556; H01M 10/613; H01M 10/625

(52) U.S. Cl. CPC H01M 10/6556; H01M 10/613; H01M 10/625; H01M 2220/20

(57) ABSTRACT

A battery device of a motor vehicle is disclosed. The battery device includes a battery housing with a cell stack of rechargeable individual battery cells that are stacked one on top of the other with contact along a stack center axis in a stack direction arranged therein. The battery housing includes a housing base, on which the cell stack is arranged and held in a flat manner with contact. For controlling a temperature of the cell stack, the housing base has a heat exchanger section, through which fluid is flowable. The heat exchanger section is reinforced via a profile structure.

### CROSS-REFERENCE TO RELATED APPLICATION

This application claims priority to German Application No. DE 10 2021 207 252.6 filed on Jul. 8, 2021, the contents of which are hereby incorporated by reference in its entirety.

### TECHNICAL FIELD

The invention relates to a battery device and to a use thereof in a motor vehicle.

### BACKGROUND

Structural solutions for battery devices are well known. With increasing demands on the accident safety thereof, however, there is the need for being able to offer structurally improved solutions for battery devices.

The object of the invention lies in specifying an improved or at least another embodiment of a battery device. An attempt is to in particular be made to make a battery device more resistant against external force loads.

In the case of the present invention, this object is solved in particular by means of the subject matters of the independent claims. Advantageous embodiments are subject matter of the dependent claims and of the description.

### SUMMARY

The basic idea of the invention lies in combining the function of a cooling system and that of a housing reinforcement for absorbing force effects in a housing base of a battery housing of a battery device.

For this purpose, it is provided that the battery device according to the invention, which can be used in particular in a motor vehicle, has a battery housing, in which at least one cell stack of rechargeable individual battery cells, which are stacked one on top of the other with contact along a stack center axis in a stack direction, is arranged and/or encased. The battery housing thereby has a, advantageously one-piece or multi-piece housing base, on which the cell stack is arranged in a flat manner with contact or is arranged and held indirectly, in particular by interconnecting a contact means. In the case of the first alternative, the cell stack can, for example, be fixed and positioned on a large surface of the housing base so that it abuts in a flat and/or gap-free manner against this large surface. In the case of the second alterative, it can advantageously be provided, in particular when a flat and/or gap-free abutment of the cell stack against a large surface of the housing base cannot be attained, for example due to manufacturing tolerances, which are unavoidable during the production of the battery device and the components thereof, and/or in order to improve a thermal connection of the cell stack to the housing base, that a contact means, in particular a heat conducting compound or a heat conducting mat, which connects the cell stack to the housing base, in particular in a gap-free manner, is arranged between the cell stack and the housing base. To be able to control the temperature of the cell stack, which can heat up during operation, and optionally other components of the battery device, which are arranged in the battery housing, it is provided that the housing base has a heat exchanger section, through which fluid flows or can flow, for controlling the temperature of the cell stack. In a heating operation, the heat exchanger section can thereby either serve as heat source, wherein the cell stack is heated up, or, in a cooling operation, it can be operated as heat sink, whereby the cell stack is cooled. Depending on the mode of operation, in which the heat exchanger section is operated, the fluid flowing through it either provides the heat energy required for the heat-up, or discharges resulting heat energy. In particular, the temperature of the cell stack can thereby be maintained within a specified or specifiable operating temperature window.

In order to simultaneously provide a relatively high resistance of the battery device against elastic and plastic deformations as a result of an application of force or force effect, respectively, in addition to the temperature control function, it is provided that the housing base is reinforced by means of a profile structure, in particular transversely and/or longitudinally with respect to the stack center axis. The profile structure has the positive effect that, on the one hand, the housing base is relatively resistant against elastic and plastic deformations as a result of an application of force to the battery housing, whereby the cell stack and optionally other components of the battery device, which are arranged in the battery housing, are protected against damage. On the other hand, the profile structure can serve as energy absorber and/or impact absorber, at least to a certain degree, thus define a type of crash structure, in that it absorbs and/or dissipates the energy converted during an application of force by means of elastic and/or plastic deformation and/or heat-up. In other words, the battery device can thus withstand relatively high force effects.

In the context of the present invention, the term of the stiffness is advantageously understood as the resistance of a body against an elastic and plastic deformation as a result of an application of force. In this context, it is also important to explain that said application of force to the battery housing or to the housing base, respectively, can be the result of an accident, during which an external force acts on the battery housing from below and/or laterally and/or from the font.

The profile structure advantageously has housing base-integral struts and duct cavities, which extend over the entire housing base and/or which can be formed by the latter. When looking at the profile structure in the cross section, the struts and duct cavities can define a type of buttress or truss pattern, which is preferably designed with a view to an optimal energy absorption capacity, i.e. to a maximum reinforcement of the housing base. The duct cavity cross sectional surfaces of the duct cavities are in particular designed to be triangular, quadrangular, polygonal, or circular. It is conceivable that the profile structure is integrated in the heat exchanger section or is formed by the latter.

Further advantageously, however, it can be provided that, in addition to the heat exchanger section, the housing base has a profile structure section, which is functionally and/or spatially separate with respect to the heat exchanger section, wherein said profile structure is formed by the heat exchanger section and/or the profile structure section. This means that even though the profile structure section and the heat exchanger section can be functionally and/or spatially separated elements, said profile structure is formed by the heat exchanger section and/or the profile structure section. The housing base can thus be designed to be relatively stiff.

The profile structure section can have several hollow profile ducts, which are aligned parallel to one another and which are oriented in parallel or transversely in particular to the stack center axis, and which are advantageously designed to have a constant cross sectional surface with respect to their main expansion. In their main expansion, the hollow profile ducts advantageously in each case define a profile duct center axis. The profile duct center axes can lie in a common plane or can span such a common plane, wherein this plane is preferably oriented in parallel with respect to one or all large surfaces of the housing base. The hollow profile ducts can furthermore in each case have a clear hollow profile cross sectional surface, which is constant in terms of surface area with respect to the main expansion of a respective hollow profile duct. The hollow profile cross sectional surfaces of the hollow profile ducts are advantageously framed completely all around by hollow profile duct walls of the respective hollow profile duct. Two directly adjacent hollow profile ducts optionally share a hollow profile duct wall.

Further advantageously, said hollow profile cross sectional surfaces of the hollow profile ducts can have a triangular, quadrangular, polygonal, or circular surface shape and can be designed to be constant in terms of surface area over the entire length of a respective hollow profile duct. Here, the specification “over the entire length” advantageously also refers to the respective main expansion of the hollow profile duct. Corresponding hollow profile ducts can thus be produced cost-efficiently and in large quantities.

It is furthermore advantageous when a reinforcing element, which is formed separately with respect to the housing base, is inserted in at least a single one or in at least 10% or maximally 90% of said hollow profile ducts of the profile structure section. The reinforcing elements can in each case be realized by means of a thermally insulating and/or energy-absorbing material, this can be PU foam, for example. The reinforcing elements can furthermore be formed by means of a shock-absorbing material or can have such a shock-absorbing material. The battery housing as a whole can be insulated thermally by means of the profile structure section, which is equipped with such reinforcing elements and/or an improved absorption and/or an improved stiffness can be attained.

At least one such reinforcing element can in particular extend in the direction of a profile duct center axis of a hollow profile duct, in which the reinforcing element is inserted, over at least 10% and/or over maximally 90% or the entire length of the respective hollow profile duct. In the alternative or in addition, at least one such reinforcing element can fill a clear hollow profile cross sectional surface of the respective hollow profile duct by at least 10% and/or over maximally 90% or completely in the inserted state, and/or can support itself with contact on a hollow profile duct wall of the respective hollow profile duct, which frames the respective clear hollow profile cross sectional surface all around. It can in particular be provided that when inserted in a hollow profile duct, each reinforcing element is fixed to a hollow profile duct wall of the respective hollow profile duct, wherein a substance-to-substance bond, for example an adhesion or welding, or a non-positive and/or positive connection, for example a clamping or screw-connection, can advantageously be realized. The respective reinforcing elements are thus captively, but optionally releasably connected to the housing base.

The heat exchanger section can further in particular have several fluid ducts, which are aligned parallel to one another and which are oriented in parallel or transversely in particular to the stack center axis, and which are designed to have a constant cross sectional surface and through which fluid flows or can flow. The fluid ducts are advantageously connected to one another so as to communicate fluidically, so that a fluid path for fluid, along which the heat exchanger section can be flushed by fluid, can extend through said fluid ducts. The fluid ducts of the heat exchanger section advantageously in each case define a fluid duct center axis, wherein they can lie in a common further plane or span such a plane, respectively. This further plane can be oriented in parallel with respect to one or all large surfaces of the housing base as well as with respect to the above-described plane of the profile structure section. The fluid ducts can furthermore in each case have a clear flow cross sectional surface, through which fluid can flow or flows and which is constant in terms of surface area over the entire length, i.e. in the main expansion direction thereof. The flow cross sectional surfaces of the fluid ducts are advantageously framed completely all around by fluid duct walls of the respective fluid duct. Two directly adjacent fluid ducts optionally share a fluid duct wall.

It can further be provided that said clear flow cross sectional surfaces of the fluid ducts have a triangular, quadrangular, polygonal, or circular surface shape and are constant in terms of surface area over the entire length of a respective fluid duct. Corresponding fluid ducts can thus be produced cost-efficiently and in large quantities.

Said fluid path can furthermore be designed in a meander-shaped manner and can extend transversely or parallel with respect to the stack center axis, so that the heat exchanger section can be flown through in the stack direction or transversely thereto in the direction of a stack center transverse axis. Different temperature control images can thus be realized on the cell stack.

It is further advantageous when the housing base is formed by a single or several base bodies, which are in each case monolithically cohesive assemblies. In the alternative or in addition, the base body or the base bodies can in each case have a heat exchanger section and a profile structure section. When it is formed from a single base body, the housing base thus forms a one-piece assembly, which can in particular have said heat exchanger section and the profile structure section. Otherwise, when the housing base consists of multiple pieces, several, in each case one-piece base bodies are present, which, when assembled, form the housing base. In this case, each base body has a separate heat exchanger section and/or a profile structure section, wherein it is at least conceivable that the several heat exchanger sections are connected to one another so as to communicate fluidically.

It is furthermore advantageous when the housing base is realized by means of an extrusion profile, in particular an aluminum extrusion profile, and/or when the base body or the base bodies are realized by means of an extrusion profile, in particular an aluminum extrusion profile. It is thus possible to produce a one-piece housing base or base body, respectively, which has a heat exchanger section and profile structure section, relatively cost-efficiently. Advantageously, an extrusion profile optionally corresponds to an extruded section. It goes without saying that, in addition to aluminum or aluminum alloys, other materials can be used for the production of such an extrusion profile, in particular known non-ferrous alloys, but also extrudable synthetic, natural, and composite materials are also possible.

The cell stack can furthermore have a stack center transverse axis, which stands vertically on the stack center axis and which, together with the stack center axis, spans a cell plane, wherein the profile structure section has hollow profile ducts, which are parallel to one another and which in each case define a profile duct center axis, wherein they span a common plane and wherein the heat exchanger section has fluid ducts, which are parallel to one another and which in each case define a fluid duct center axis, wherein they span a common further plane. To now attain an optimal temperature control of the cell stack, either the further plane can be arranged in a sandwich-like manner between the plane and the cell plane, or the plane can be arranged in a sandwich-like manner between the further plane and the cell plane. The plane, the further plane, and the cell plane are thereby advantageously aligned parallel to one another. The profile structure section or the heat exchanger section is thus quasi arranged directly on the cell stack. It is preferred when the heat exchanger section lies directly on the cell stack, so that the further plane is arranged in a sandwich-like manner between the plane and the cell plane. This has the advantage that the temperature of the cell stack can be controlled optimally by means of the heat exchanger section.

According to a preferred exemplary embodiment of the invention, it is possible that the housing base is realized by means of a one-piece aluminum extrusion profile. Said housing base has, in an integral manner, the heat exchanger section and a profile structure section, which, together, form said profile structure, in that the profile structure section has several hollow profile ducts, which are aligned parallel to one another and which are oriented in parallel with respect to the stack center axis and which have a constant cross sectional surface and which open out on two flat or essentially flat front surfaces of the housing base, which are oriented oppositely to one another, in each case by forming triangular, quadrangular, polygonal, or circular profile duct mouth openings, and furthermore in that the heat exchanger section has several fluid ducts, which are parallel to one another and which are oriented in parallel with respect to the stack center axis, and which have a constant cross sectional surface and through which fluid flows or can flow, and which open out on said two front surfaces of the housing base, which are oriented oppositely to one another, in each case by forming triangular, quadrangular, polygonal, or circular profile duct mouth openings. A fluid deflecting plate, which covers the profile duct mouth openings and the fluid duct mouth openings in a fluid-tight manner, can thereby be arranged on the one front surface of the housing base, and a fluid supply plate, which covers the profile duct mouth openings and fluid duct mouth openings in a fluid-tight manner there, can be arranged on the other front surface of the housing base. To attain that fluid can flow from the one into the next fluid duct, it is provided that fluid duct walls between the adjacent fluid ducts return in particular by a few centimeters or millimeters with respect to the fluid deflecting plate in the region of their fluid duct mouth openings, which are covered by the fluid deflecting plate, so that an overflow region, through which fluid can flow from the one fluid duct into the other fluid duct, is defined between two adjacent fluid ducts. It is likewise provided that fluid duct walls between the adjacent fluid ducts return with respect to the fluid supply plate in the region of their fluid duct mouth openings, which are covered by the fluid supply plate, so that a further overflow region, through which fluid can flow from the one fluid duct into the other fluid duct, is defined between two adjacent fluid ducts. With the help of said overflow regions, the fluid ducts can form a meander-shaped fluid path for fluids, which extends parallel with respect to the stack center axis and along which the heat exchanger section can be flushed by fluid in the stack direction. The fluid supply plate can furthermore have two supply connections, through which fluid can flow into and flow out of the fluid ducts.

Advantageously, the one supply connection is an inlet, and the other one is an outlet. Inlet and outlet in each case form a cylinder sleeve, the cylinder sleeve axes of which stand vertically on the fluid supply plate. The battery housing can furthermore have an, in particular one-piece, cover, which completely or at least partially spans the cell stack, and which, with its cover edge, which is oriented towards the housing base, is fixed thereto. A relatively cost-efficient and relatively stiff battery device is thus specified.

The invention furthermore comprises a use of a battery device according to the preceding description in an electrically driven motor vehicle, wherein the battery device can be integrated in said motor vehicle and is connected or can be connected to a drive train and/or an on-board system of the motor vehicle.

In summary, it can be stated: The present invention preferably relates to a battery device, comprising a battery housing, in which a cell stack of rechargeable individual battery cells, which are stacked one on top of the other with contact along a stack center axis in a stack direction, is arranged and/or encased, wherein the battery housing has a housing base, on which the cell stack is arranged and held in a flat manner with contact, wherein, for controlling the temperature of the cell stack, the housing base has a heat exchanger section, through which fluid flows or can flow, and which is reinforced against deformation by means of a profile structure.

Further important features and advantages of the invention follow from the subclaims, from the drawings, and from the corresponding figure description on the basis of the drawings.

It goes without saying that the above-mentioned features and the features, which will be described below, cannot only be used in the respective specified combination, but also in other combinations, or alone, without leaving the scope of the present invention.

Preferred exemplary embodiments of the invention are illustrated in the drawings and will be described in more detail in the following description, whereby identical reference numerals refer to identical or similar or functionally identical components.

### BRIEF DESCRIPTION OF THE DRAWINGS

In each case schematically,

FIG. 1 shows a perspective view of a preferred exemplary embodiment of the battery device according to the invention, wherein a cover of the battery housing of the battery device is removed in order to better recognize the cell stack of the battery device,

FIG. 2 shows the battery device from FIG. 1 in a sectional view according to a plane illustrated in FIG. 1 by means of a dashed line in viewing direction of an arrow II, wherein the cover of the battery housing is now also illustrated,

FIG. 3 shows a perspective view of a preferred further exemplary embodiment of the battery device according to the invention, and lastly

FIG. 4 shows a sectional view through a housing base of the battery housing of a battery device according to the invention according to a further exemplary embodiment at the height of a heat exchanger section.

### DETAILED DESCRIPTION

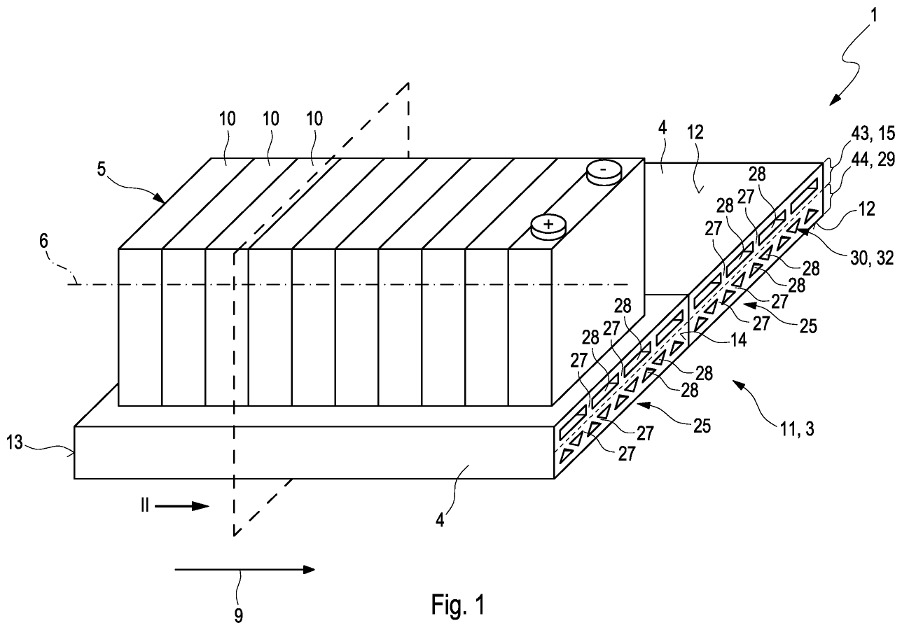

FIGS. 1 to 4 show preferred exemplary embodiments of a battery device, which is identified as a whole with reference numeral 1, the essential components of which are a battery housing 3 and one or several cell stacks 5, wherein the latter consists of rechargeable individual battery cells 10, which are stacked one on top of the other with contact along a stack center axis 6, which is suggested by means of a dash-dotted line, in a stack direction 9. The battery device 1 can preferably be used in an electrically driven motor vehicle 2, wherein the battery device 1 is integrated in said motor vehicle and is connected or can be connected to a drive train and/or an on-board system of the motor vehicle 2 for the purpose of the energy supply thereof.

With reference to FIG. 1, it is important to note that, according to a preferred exemplary embodiment, the battery device 1, which is illustrated there in perspective view in a highly simplified manner, is formed without cover, whereby this allows a view in particular onto the above-described cell stack 5 and, due to the fact that the cover is considered to be part of the battery housing 3, onto a remaining portion of the battery housing 3.

In an exemplary manner, the remaining portion of the battery housing 3 is a housing base 11 formed of multiple pieces, which has two oppositely oriented large surfaces 12 as well as at least two oppositely oriented front surfaces 13, 14. The cell stack 5 is arranged in a flat manner with contact on one of the identified large surfaces 12 of the housing base 11 and is held and positioned by means of non-illustrated fixing means.

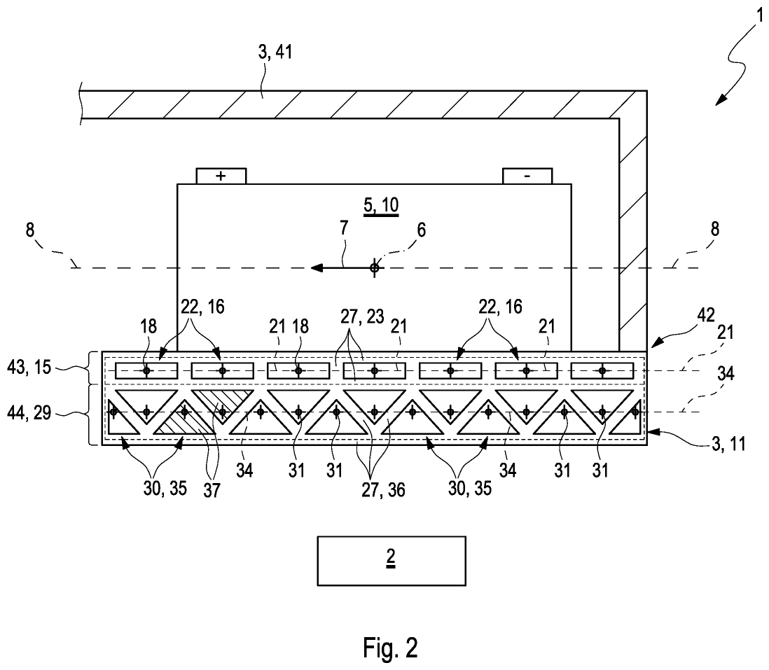

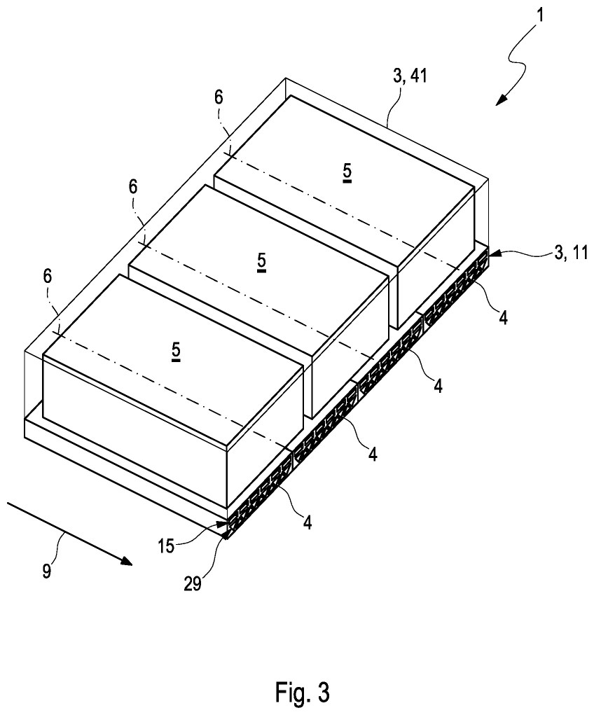

It can be seen in FIGS. 1, 2, and 3 that the housing base 11 has at least one, or according to the exemplary embodiments according to FIGS. 1 and 3, also several separate base bodies 4, which are joined in a releasable or non-releasable manner, and which are in each case realized in an exemplary manner by means of monolithically cohesive assemblies. In practice, these are preferably one-piece aluminum extrusion profiles. The base bodies 4 in each case have an integral profile structure 25 of several struts 27 and several clear duct cavities 28, which extend longitudinally completely through the respective base body 4, see in particular FIGS. 1, 2, and 3. It is provided that the struts 27 and duct cavities 28 of a base body 4 form a partial heat exchanger section, through which fluid flows or can flow, and a functionally and spatially separated partial profile structure, wherein in the assembled state of the battery device 1 illustrated in FIGS. 1 and 2, all partial heat exchanger sections of the base body 4 arranged on an upper housing base half 43 of the housing base 11 facing the cell stack 5 are combined and, together, are referred to as heat exchanger section 15 of the housing base 11. Due to the fact that the partial heat exchanger sections are connected to one another so as to communicate fluidically, fluid flows or can flow through the heat exchanger section 15, so that it can serve for controlling the temperature of the cell stack 5. The partial profile structures of the base bodies 4, which are arranged on a lower housing base half 44 of the housing base 11 facing away from the cell stack 5, are likewise grouped together and, together, are referred to as profile structure section 29 of the housing base 11. The heat exchanger section 15 and the profile structure section 29 are suggested so as to be framed in a dotted manner in FIGS. 1 and 2, so that the above-described groupings can also be seen. By means of the profile structure 25, i.e. by means of the heat exchanger section 15 and the profile structure section 29, the housing base 11 or the battery housing 3, respectively, are reinforced transversely and longitudinally with respect to the stack center axis 6, whereby the housing base 11 or the entire battery housing 3, respectively, is relatively resistant against elastic and plastic deformations as a result of an external application of force to the battery device 1. This has the advantage in particular that the cell stack 5 and optionally other non-illustrated components of the battery device 1, which are arranged in the battery housing 3, are protected relatively well against damage.

FIG. 2 shows the battery device from FIG. 1 in a sectional view according to a plane, which is illustrated in FIG. 1 by means of a dashed line, in the viewing direction of an arrow II, wherein a cover 41 of the battery housing 3 is now also illustrated, which spans the cell stack 5 transversely and longitudinally with respect to the stack center axis 6, which is suggested in FIG. 2 only by means of an x mark, and which is fixed with its cover edge 42, which is oriented towards the housing base 11, thereto, for example by means of a welding or adhesion. It can be seen in FIG. 2 that the cell stack 5 can define a stack center transverse axis 7, which stands vertically on the stack center axis 6 and which, together with the stack center axis 6, spans a cell plane 8, which is suggested by means of dashed lines and which is advantageously parallel to the large surfaces 12 of the housing base 11. Said profile structure section 29 has hollow profile ducts 30, which are parallel to one another and which are realized by means of the duct cavities 28 and which in each case define a profile duct center axis 31 suggested by means of an x mark and which advantageously extend completely through the respective base body 4. The hollow profile ducts 30 or the profile duct center axes 31 thereof, respectively, span a plane 34, which is suggested by means of dashed lines in FIG. 2, as is the cell plane 8. Said heat exchanger section 15 has fluid ducts 16, which are parallel to one another and which are likewise realized by means of the duct cavities 28 and which in each case define a fluid duct center axis 18, wherein they span a further plane 21, which is suggested by means of dashed lines in FIG. 2, as is the cell plane 8 and the plane 34. The fluid ducts 16 advantageously also extend completely through the respective base body 4. To be able to realize an optimal temperature control of the cell stack 5, it is provided in an exemplary manner that the plane 34, the further plane 21, and the cell plane 8 are aligned parallel to one another and that the further plane 21 is arranged in a sandwich-like manner between the plane 34 and the cell plane 8, even though it would generally be perceivable to proceed in reverse, and to arrange the plane 34 in a sandwich-like manner between the further plane 21 and the cell plane 8. At least according to the arrangement illustrated in the figures, the heat exchanger section 15 thus always lies directly on the cell stack 5, whereby an optimal temperature control is ensured.

It can furthermore be seen in FIG. 2 that the hollow profile ducts 30 in each case have a clear, triangular hollow profile cross sectional surface 35, which is constant in terms of surface area over the entire length of a respective hollow profile duct 30. In the present case, the hollow profile cross sectional surfaces 35 of the hollow profile ducts 30 are framed completely all around by the hollow profile duct walls 36 of the respectively hollow profile duct 30, which is realized by means of the struts 27. It is furthermore illustrated in FIG. 2 that reinforcing elements 37, which are formed separately with respect to the housing base 11, are inserted in said hollow profile ducts 30 of the profile structure section 29, wherein only two such reinforcing elements 37 are suggested by means of shading in the present case. These reinforcing elements 37 can be realized by means of a thermally insulating and energy-absorbing material, this can be, for example, a PU foam or a bulk material. It can furthermore be seen that the fluid ducts 16 in each case have a clear flow cross sectional surface 22, through which fluid can flow or flows, and which is constant in terms of surface area and rectangular over the entire length of a respective fluid duct 16. The flow cross sectional surfaces 22 of the fluid ducts 16 are advantageously framed completely all around by fluid duct walls 23 of the respective fluid duct 16, which are likewise realized by means of the struts 27. A motor vehicle 2 is further suggested in FIG. 2 by means of a simple box, in which the battery device 1 can be integrated.

FIG. 3 shows a perspective view of a preferred further exemplary embodiment of the battery device 1 according to the invention, wherein, in contrast to the above, the cover 41 is now illustrated in a transparent manner, so that it can be seen that a total of three separate cell stacks 5 are arranged on the housing base 11, which has four separate, joined base bodies 4, and are held and positioned by means of non-illustrated fixing means. The housing base 11 has a heat exchanger section 15, which faces the cell stack 5, as well as a profile structure section 29.

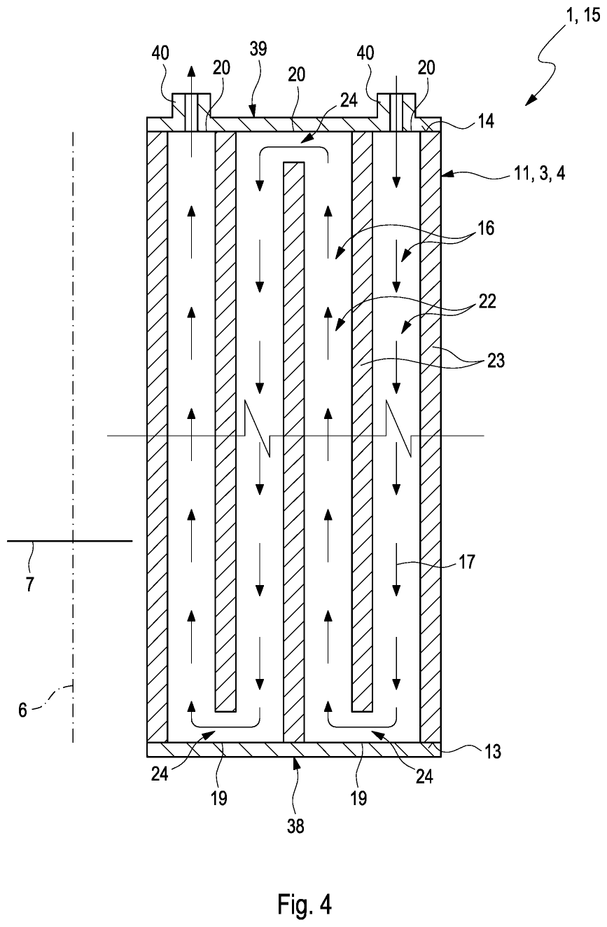

When looking at FIG. 4, a horizontal section through a heat exchanger section 15 of a housing base 11 of the battery housing 1 according to a further exemplary embodiment can be seen. The fluid ducts 16 of this heat exchanger section 15 virtually correspond to those of the previous exemplary embodiments, so that they extend parallel to one another through the entire housing base 11, have a clear flow cross sectional surface 22, which can be flushed by fluid, and are framed by a fluid duct wall 23. A fluid path 17, which extends along the fluid ducts 16 in a meander-shaped manner and transversely with respect to the stack center axis 6, is furthermore shown in FIG. 4 with a plurality of arrows, so that the heat exchanger section 15 can be flown through transversely to the stack direction 9 in the direction of a stack center transverse axis 7. It can further be seen in FIG. 4 that the fluid ducts 16 open out on the two front surface 13, 14, which are oriented oppositely to one another, of the housing base 11, in each case by forming fluid duct mouth openings 19, 20, wherein, when looking at FIG. 1, it is also important to mention that the hollow profile ducts 30 also open out on the two front surface 13, 14, which are oriented oppositely to one another, of the housing base 11, in each case by forming profile duct mouth openings 32.

It can furthermore be seen in FIG. 4 that a fluid deflecting plate 38, which covers the profile duct mouth openings 32 and the fluid duct mouth openings 19 in a fluid-tight manner, is arranged on the one front surface 13 of the housing base 11, and a fluid supply plate 39, which covers the profile duct mouth openings and fluid duct mouth openings 20 in a fluid-tight manner there, is arranged on the other front surface 14 of the housing base 11. The fluid duct walls 23 between the adjacent fluid ducts 16 thereby return with respect to the fluid deflecting plate 38 in the region of their fluid duct mouth openings 19, which are covered by the fluid deflecting plate 38, so that an overflow region 24, through which fluid can flow from the one fluid duct 16 into the other fluid duct 16, is defined between two adjacent fluid ducts 16. It is likewise provided on the opposite side that fluid duct walls 23 between the adjacent fluid ducts 16 return with respect to the fluid supply plate 39 in the region of their fluid duct mouth openings 20, which are covered by the fluid supply plate 39, so that a further overflow region 24, through which fluid can flow from the one fluid duct 16 into the other fluid duct 16, is defined between two adjacent fluid ducts 16. The fluid ducts 16 are thus connected to one another so as to communicate fluidically, and can be flushed by fluid for the purpose of controlling the temperature of the cell stacks 5. It is also suggested in FIG. 4 that the fluid supply plate 39 has two supply connections 40, through which fluid can flow into and out of the fluid ducts 16.

1. A battery device of a motor vehicle, comprising:
a battery housing with a cell stack of rechargeable individual battery cells that are stacked one on top of the other with contact along a stack center axis in a stack direction arranged therein,
the battery housing including a housing base and the cell stack is arranged and held in a flat manner with contact on the housing base, and
wherein for controlling a temperature of the cell stack, the housing base has a heat exchanger section, through which fluid is flowable, and the heat exchange section is reinforced via a profile structure.

2. The battery device according to claim 1, wherein the profile structure includes struts and duct cavities.

3. The battery device according to claim 1, wherein:
the housing base has a profile structure section that is functionally separate with respect to the heat exchanger section, and
wherein the profile structure is defined by at least one of the heat exchanger section and the profile structure section.

4. The battery device according to claim 3, wherein the profile structure section includes a plurality of hollow profile ducts that are parallel to one another and have a constant cross sectional surface.

5. The battery device according to claim 4, wherein the constant cross sectional surface of the plurality of hollow profile ducts respectively have a triangular, quadrangular, polygonal, or circular surface shape and are constant in terms of surface area over an entire length of a respective hollow profile duct.

6. The battery device according to claim 4, further comprising reinforcing elements provided separately with respect to the housing base and inserted in the plurality of hollow profile ducts of the profile structure section.

7. The battery device according to claim 6, wherein at least one of:
at least one of the reinforcing elements extends over a length of the respective hollow profile duct in a direction of a profile duct center axis of the respective hollow profile duct, in which the at least one reinforcing element is inserted, and
the reinforcing elements fill a clear hollow profile cross sectional surface of the respective hollow profile duct in an inserted state, and support themselves with contact on a hollow profile duct wall of the respective hollow profile duct, which frames the respective clear hollow profile cross sectional surface all around.

8. The battery device according to claim 1, wherein:
the heat exchanger section includes a plurality of fluid ducts that are parallel to one another and have a constant cross sectional surface and through which fluid is flowable, the plurality of fluid ducts being connected to one another so as to communicate fluidically,
wherein a fluid path for fluid, along which the heat exchanger section can be flushed by fluid, extends through the plurality of fluid ducts.

9. The battery device according to claim 8, wherein flow cross sectional surfaces of the plurality of fluid ducts, through which fluid is flowable, have a triangular, quadrangular, polygonal, or circular surface shape and are constant in terms of surface area over an entire length of a respective fluid duct.

10. The battery device according to claim 8, wherein the fluid path is structure in a meander-shaped manner and extends transversely or parallel with respect to the stack center axis, so that the heat exchanger section can be flown through in the stack direction or transversely thereto in a direction of a stack center transverse axis.

11. The battery device according to claim 1, wherein at least one of:
the housing base is provided by a single or several base bodies that are in each case monolithically cohesive assemblies, and
the single base body or the several base bodies in each case have a heat exchanger section and a profile structure section.

12. The battery device according to claim 1, wherein at least one of:
the housing base is structured as an extruded profile, and
the base body is structured as an extruded profile.

13. The battery device according to claim 1, wherein:
the cell stack has a stack center transverse axis that stands vertically on the stack center axis and, together with the stack center axis, spans a cell plane,
the profile structure section has hollow profile ducts that are parallel to one another and in each case define a profile duct center axis, wherein the hollow profile ducts span a common plane,
the heat exchanger section has fluid ducts that are parallel to one another and in each case define a fluid duct center axis, wherein the fluid ducts span a common further plane, and
wherein either the common further plane of the fluid ducts is arranged in a sandwich-like manner between the common plane of the hollow profile ducts and the cell plane, or the common plane of the hollow profile ducts is arranged in a sandwich-like manner between the common further plane of the fluid ducts and the cell plane.

14. The battery device according to claim 1, wherein:
the housing base is provided via at least one one-piece, aluminum extrusion profile that has the heat exchanger section and a profile structure section that together form said profile structure,
the profile structure section includes a plurality of hollow profile ducts that are aligned parallel to one another and oriented in parallel with respect to the stack center axis and have a constant cross sectional surface and open out on two front surfaces of the housing base, the two front surfaces oriented oppositely to one another in each case by providing profile duct mouth openings,
the heat exchanger section includes a plurality of fluid ducts that are parallel to one another and oriented in parallel with respect to the stack center axis and have a constant cross sectional surface and through which fluid is flowable, the plurality of fluid ducts open out on the two front surfaces of the housing base that are oriented oppositely to one another in each case by providing fluid duct mouth openings,
wherein a fluid deflecting plate that covers the profile duct mouth openings and the fluid duct mouth openings in a fluid-tight manner, is arranged on a first front surface of the housing base, and a fluid supply plate that covers the profile duct mouth openings and fluid duct mouth openings in a fluid-tight manner, is arranged on a second front surface of the housing base,
wherein fluid duct walls between the adjacent fluid ducts return with respect to the fluid deflecting plate in a region of the fluid duct mouth openings that are covered by the fluid deflecting plate, so that an overflow region, through which fluid can flow from the one fluid duct into the other fluid duct, is defined between two adjacent fluid ducts,
wherein fluid duct walls between the adjacent fluid ducts return with respect to the fluid supply plate in a region of the fluid duct mouth openings that are covered by the fluid supply plate, so that an overflow region, through which fluid can flow from the one fluid duct into the other fluid duct, is defined between two adjacent fluid ducts,
wherein the fluid supply plate has two supply connections, through which fluid can flow into and flow out of the fluid ducts,
wherein the fluid ducts define a meander-shaped fluid path for fluids, which extends parallel with respect to the stack center axis and along which the heat exchanger section can be flushed by fluid in the stack direction, and
wherein the battery housing includes a cover that spans the cell stack and, with a cover edge oriented towards the housing base, is fixed thereto.

15. An electrically driven motor vehicle, comprising: a battery device integrated in said motor vehicle and connectable to at least one of a drive train and an on-board system of the motor vehicle, the battery device including:
a battery housing with a cell stack of rechargeable individual battery cells that are stacked one on top of the other with contact along a stack center axis in a stack direction arranged therein,
the battery housing including a housing base and the cell stack is arranged on the housing base and held in a flat manner with contact on the housing base, and
wherein for controlling a temperature of the cell stack, the housing base has a heat exchanger section, through which fluid is flowable, and the heat exchange section is reinforced via a profile structure.

16. The electrically driven motor vehicle according to claim 15, wherein the profile structure includes struts and duct cavities.

17. The electrically driven motor vehicle according to claim 15, wherein the housing base has a profile structure section separate from the heat exchanger section.

18. The electrically driven motor vehicle according to claim 17, wherein the profile structure section includes a plurality of hollow profile ducts.

19. The electrically driven motor vehicle according to claim 18, wherein the plurality of hollow profile ducts are parallel to one another and have a constant cross sectional surface.

20. The electrically driven motor vehicle according to claim 18, further comprising reinforcing elements disposed in the plurality of hollow profile ducts of the profile structure section.
